(19) United States
(12) Patent Application Publication
(10) Pub. No.: US 2019/0100275 A1
(43) Pub. Date: Apr. 4, 2019

(54) SMART CRANK CONTROL FOR E-BIKE

(71) Applicant: PalTorc, Inc., Milpitas, CA (US)

(72) Inventors: Jyh-Ping Johnny Wang, Milpitas, CA (US); Steve Chih-Ching Chou, Milpitas, CA (US); Dann Wang, Milpitas, CA (US)

(21) Appl. No.: 15/857,039

(22) Filed: Dec. 28, 2017

Related U.S. Application Data
(63) Continuation-in-part of application No. 15/814,364, filed on Nov. 15, 2017.
(60) Provisional application No. 62/567,391, filed on Oct. 3, 2017.

(51) Int. Cl. B62M 6/50; H01R 39/12

(52) U.S. Cl. CPC B62M 6/50; H01R 39/12

(57) ABSTRACT

The bike's crank speed and crank position are sensed via a micro controller, torque sensor, gyro and accelerator disposed on the bike's crank. External power and control signals can be passed to and from the crank micro controller and the e-bike controller through a throttle connector of the e-bike controller via slip rings around the crank hub with bearings, fixed rings, bushings or springs contacting the respective slip rings. Throttle data can also be provided to the e-bike controller wirelessly via a wireless dongle coupled to the throttle connector of e-bike controller.

### PRIORITY

This application is a continuation-in-part application of U.S. patent application Ser. No. 15/814,364, filed Nov. 15, 2017, which claims the priority benefit of U.S. Provisional Application No. 62/567,391 filed on Oct. 3, 2017, both which are hereby incorporated herein by reference in their entirety.

### FIELD

The present invention relates generally to electrical bicycles (e-bikes), and more particularly, to a smart crank control coupled to the throttle control of the e-bike.

### BACKGROUND

Conventional e-bike motor output power control is based on an input to the motor controller of the degree of rotation of the hand throttle, which is moved by the rider. This functions satisfactorily where the e-bike is solely or primarily powered by the electric motor. But a hand throttle is difficult to operate when the electric motor is configured to merely assist the rider in pedaling.

In some regions, like Europe, motor power is treated as an assisting power—PAS (Pedal Assist System)—to help the person ride the e-bike more easily, and not the primary means of powering the bike. The PAS is merely an electric motor assist to the rider, so PAS is used to make riding the e-bike more like a regular bike.

In PAS systems, if biker does not pedal, the motor does not generate any output power. Speed PAS is based on biker's pedaling speed. When e-bike goes uphill, the e-bike rider will need more power from the electric motor, but they cannot get that power from a Speed PAS system because their pedaling speed is slower due to going uphill. Therefore, a torque sensor PAS system is required to sense the rider's pedaling power, so that the control system can control the motor's output power appropriately.

However, if rider's two legs stand on both pedals, the torque force will be very high. In this situation, it would be dangerous for the assist motor to generate its highest power. Therefore, the bike's crank speed and crank position need to be taken into account for safely and effectively controlling the assist motor for the bike.

Providing torque and crank position data to the motor controller is a challenge. A wireless transmission means can be used. However, not all of the e-bike controllers on the market have wireless receivers. Providing an aftermarket wireless receiver for the motor controller is not a satisfactory solution either since it would require the manufacturer or rider to modify their e-bike controller hardware and software to talk to the aftermarket wireless receiver. That requires additional cost and time to adapt the motor controller to an aftermarket wireless system for receiving the torque and crank position data. Most of e-bike manufacturers are not willing to take extra steps to modify their e-bike controller hardware and software.

Another issue is that torque sensors alone are not good enough to make a torque PAS because it is necessary to detect the exact crank position to send the right control signals to control e-bike controller. Some torque sensor PAS vendors put torque sensing component(s) on pedal axle to sense the twisting power caused by both legs. But this makes it difficult to sense the crank positions and the rider's intention cannot be easily discerned. For example, reverse pedaling means the rider wants to brake; both cranks in parallel to ground position means biker is resting and the motor can adjust its power output correspondingly; when left crank is at the lowest position and right crank in upper position, the crank can detect that the rider is in a dismounting position so that motor can adjust accordingly, and so on.

Further, powering the crank sensors presents difficulties. To avoid twisting wires caused by moving crank, adding a battery on the crank itself is one way to provide power. But battery life limits the use of the smart crank system. Recharging or replacing batteries is inconvenient and can be expensive.

Therefore, there remains a need to provide an improved electric power assist for e-bikes without extra efforts to modify the e-bike controller. There is also a need to provide smart crank control for e-bikes.

### SUMMARY

The present invention addresses the above-noted drawbacks of torque pedal assist systems. The invention senses the bike's crank speed and crank position via a micro controller, torque sensor, gyro and accelerator on the bike's crank. In certain embodiments, external power and control signals are passed to and from the micro controller and the e-bike controller through a throttle connector via slip rings around the crank with pogo pins connected to respective slip rings. Alternatively, the sensor data can be provided to the e-bike controller wirelessly via a wireless dongle coupled to the throttle connector of e-bike controller.

The disclosure includes a smart crank control system for an e-bike, comprising a strain gauge disposed on the crank, a control board disposed on the crank and coupled to the strain gauge, the control board including gyro and accelerator motion sensors and a digital motion processor, and a slip ring disposed about the crank to provide for a power connection to the control board. The control board is coupled to the e-bike controller through the throttle connector of the e-bike.

The micro controller can be configured to determine a crank speed, a crank position and a torque data for the crank of the e-bike and report the crank speed, the crank position and the torque data to the e-bike controller via connection to the throttle connector. The control board can include a digital to analog converter coupled to the micro controller so that the crank speed, the crank position and the torque data for the crank of the e-bike are converted to analog throttle data for the throttle control.

The control board is coupled to the e-bike controller through the throttle connector of the e-bike via a cable or wirelessly. If wireless, the control board 106 can further include a wireless transceiver. A wireless transceiver dongle can be coupled to the e-bike controller through the throttle connector of the e-bike via a wire. The control board is then wirelessly connected to the wireless transceiver dongle. The wireless transceiver dongle can include a digital to analog converter so that a crank speed, a crank position and a torque data for the crank of the e-bike, if received in digital format, can be outputted as throttle data to the e-bike controller through throttle connector in an analog format. The e-bike controller can include a serial port wherein the wireless transceiver dongle is connected via the wire connection.

Pogo pin connectors can be coupled to the slip rings. A power input cable can be connected to the pogo pin connectors to supply power to the control board. A first end of a data cable can additionally or alternatively be connected to the pogo pin connectors. An opposing second end of the power or data cable can be connected to the throttle connector of the e-bike controller.

The disclosure also includes a method of providing electrical assistance to the rider of an e-bike. A torque data from a strain gauge disposed on a crank of the e-bike is determined by a smart crank controller. A crank speed from gyro and accelerator motion sensors and a digital motion processor provided to the crank of the e-bike is determined by a smart crank controller. A crank position from the digital motion processor provided to the crank of the e-bike is also determined by a smart crank controller. The pedaling force for the rider is determined. A data signal containing throttle data is passed through slip rings disposed around an axle of the crank of the e-bike. The data signal containing the throttle data is then passed to an e-bike controller through a throttle connector of the e-bike controller.

A first end of a data cable can be connected to the slip rings via a pogo pin connector and a second end of the data cable can be connected to the e-bike controller through the throttle connector. The torque data, crank speed and crank position can be used by the smart crank and transmitted as throttle data via a wire connection, or a wireless transceiver dongle. The throttle data communicated to the e-bike controller through throttle connector can be an analog signal.

The smart crank system can also determine whether a rider of the e-bike is reverse pedaling, whether a rider of the e-bike is resting with both cranks of the e-bike parallel to the ground, and whether the crank of the e-bike is in a dismount position. These determinations can be communicated to the e-bike controller through the throttle connector.

The disclosure further includes an e-bike. The e-bike includes a crank, an electric motor, an e-bike controller connected to the electric motor, a strain gauge disposed on the crank, a control board disposed on the crank and coupled to the strain gauge, and a slip ring disposed about the crank to provide for a rotational power coupling. The control board includes a gyro sensor, an acceleration motion sensor and a digital motion processor. The control board is coupled to the e-bike controller through the throttle connector via the plurality of slip rings and a conduit extending between the plurality of slip rings and the throttle connector of the e-bike.

The disclosure yet further discloses a smart crank control system for an e-bike. The e-bike includes a crank and an electric motor connected to an e-bike controller. The e-bike controller including a throttle connector. The smart crank system includes a control board disposed on the crank, a plurality of slip rings disposed about the crank and a plurality of metal springs disposed about the crank. The control board including a motion sensor, a digital motion processor and a micro controller. Each of the metal springs is in physical contact with a respective one of the slip rings. A power connection to the control board passes through the physical contact between at least one of the metal springs and the respective one of the slip rings. A throttle control signal or a throttle data from the control board can also be passed through the physical contact between at least one of the metal springs and the respective one of the slip rings.

A spring frame can be provided to the plurality of metal springs. The spring frame can be curved and define a plurality of apertures through which opposing ends of the plurality of metal springs can be disposed such that the opposing ends protrude inwardly of the curvature of the spring frame. An outer housing can be provided, wherein the spring frame and the plurality of springs are disposed within the outer housing, and wherein the slip rings are disposed within an inner diameter of the plurality of slip rings.

A power input cable can be connected to at least one of the plurality of metal springs. A data cable is connected to another one (or the same one) of the plurality of metal springs. The data cable can also be connected to the throttle connector of the e-bike controller.

The disclosure further includes a smart crank system comprising a control board disposed on the crank, a plurality of slip rings disposed about the crank and a plurality of curved metal springs disposed about the crank. A bearing, a non-rotating slip ring or a rotating bushing are disposed at either one or both ends of each of the plurality of curved metal springs. Each of the bearings/slip rings/bushings (ore pair thereof) is in physical contact with a respective one of the slip rings so that a power connection to the control board passes through that physical contact. An inner hub can be provided, wherein each of the plurality of metal springs is affixed to the inner hub. The bearings/slip rings/bushings contact an inner circumferential surface of a respective slip ring.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a diagram of a smart crank sensor system in accordance with certain embodiments.

FIG. 2 is another diagram of a smart crank sensor system in accordance with certain embodiments.

FIG. 3 is a further diagram of a smart crank sensor system in accordance with certain embodiments.

FIG. 4 is a perspective view of a crank with slip rings for a smart crank sensor system in accordance with certain embodiments.

FIG. 5 is an inner side view of a crank with slip rings for a smart crank sensor system in accordance with certain embodiments.

FIG. 6 is an outer side view of a crank with slip rings for a smart crank sensor system in accordance with certain embodiments.

FIG. 7 is a top view of a crank with slip rings for a smart crank sensor system in accordance with certain embodiments.

FIG. 8 is a perspective view of a slip ring and bearings connection mechanism for a smart crank sensor system in accordance with certain embodiments.

FIG. 9 is another perspective view of a skip ring and bearings connection mechanism for a smart crank sensor system in accordance with certain embodiments.

FIG. 10 is a perspective view of a slip ring and bearings connection mechanism for a smart crank sensor system showing that it is joined with the crank head in accordance with certain embodiments.

FIG. 11 is a perspective view of a bearings assembly for a slip ring and bearings connection mechanism for a smart crank sensor system

FIG. 12 is a perspective view of a bearings assembly for a slip ring and bearings connection mechanism for a smart crank sensor system

FIG. 13 is a perspective view of a spring assembly for making an electrical connection for a smart crank sensor system.

FIG. 14 is a perspective view of a spring frame for making an electrical connection for a smart crank sensor system.

FIG. 15 is a perspective view of a spring for making an electrical connection for a smart crank sensor system.

FIG. 16 is a perspective view of a spring assembly in a partial housing for making an electrical connection for a smart crank sensor system.

FIG. 17 is a perspective view of a spring assembly and slip rings for making an electrical connection for a smart crank sensor system.

FIG. 18 is a perspective view of a partial outer housing for housing components that make an electrical connection for a smart crank sensor system.

FIG. 19 is a perspective view of a crank hub containing components for making an electrical connection for a smart crank sensor system.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

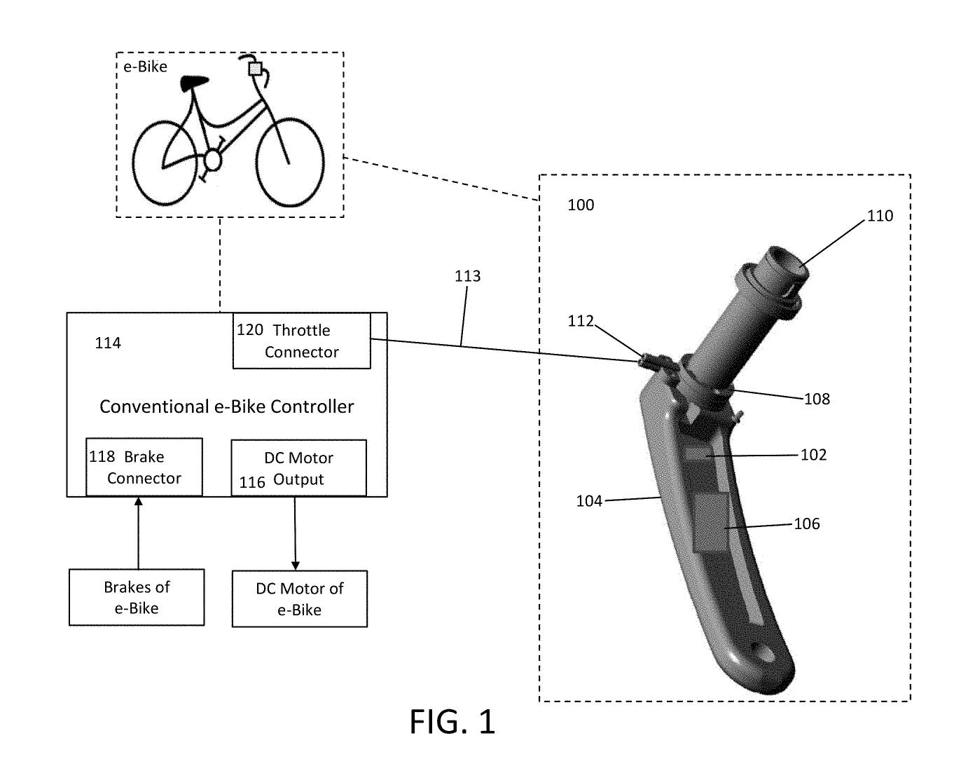

Referring to FIG. 1, the smart crank sensor system 100 for an e-bike includes a strain gauge 102 disposed on the crank 104 of the e-bike. A control board 106 is also disposed on the crank 104.

The control board 106 includes a micro controller and physical memory. Software code is stored in the memory and executed by the micro controller in order to control the operation of the smart crank system 100.

The control board 106 also includes motion sensors such as a gyro, an accelerometer, and a digital motion processor. The motion sensors provide the crank speed and position data to the digital motion processor on the control board 106.

The strain gauge 102 is coupled to the control board 106. The strain gauge 102 senses the strain in the crank, which allows the micro controller on the board 106 to determine the torque data and the pedaling force of the e-bike rider.

A plurality of slip rings 108 are disposed around the pedal axle 110 of the e-bike (to which the crank 104 is connected). In one embodiment, pogo pin connectors 112 are disposed on the slip rings 108. Two of the slip rings 108 allow electrical power connection (Vcc and Gnd) to pass to the control board 106 while disposed on the rotating crank 104. Another slip ring 108 can be used to pass an analog throttle data signal from the control board out to a cable 113 that connects to the throttle connector of the e-bike controller 114.

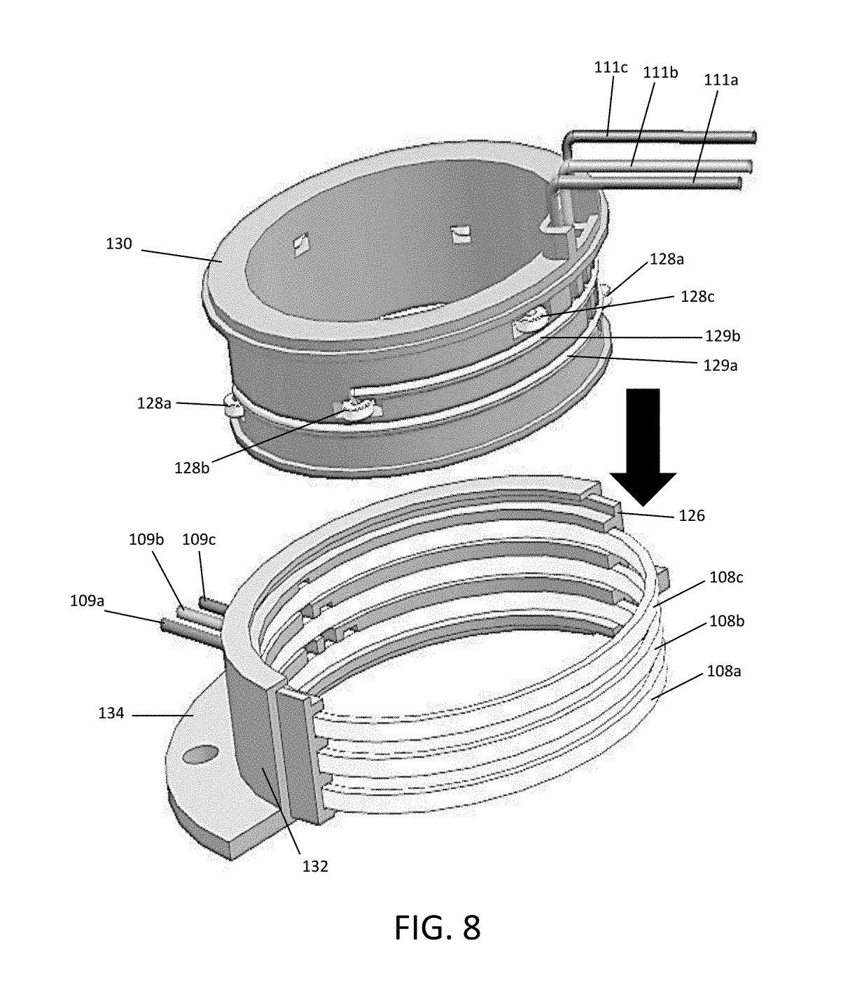

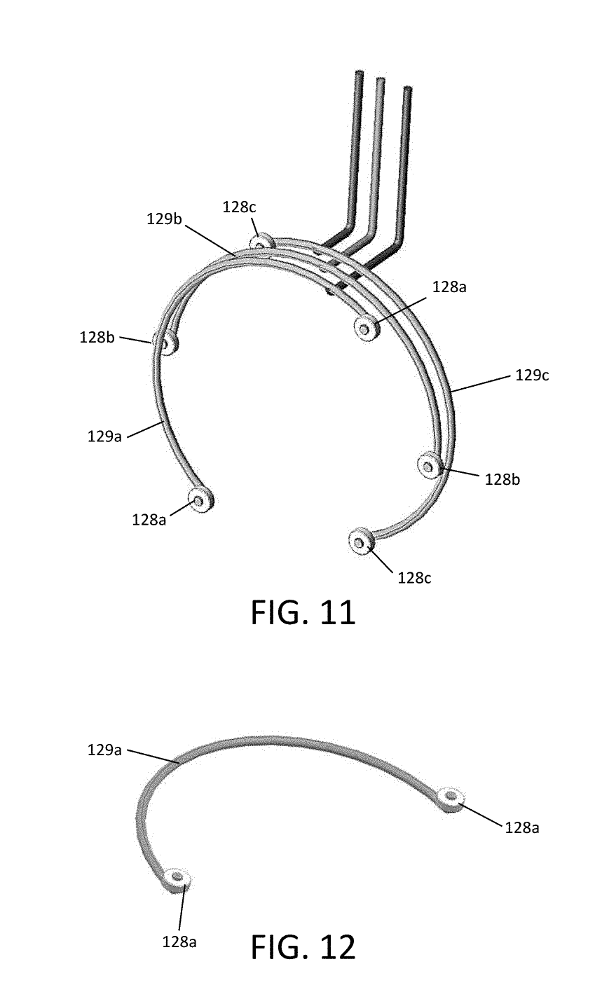

The pogo pins 112 provide a convenient means for connecting electrical power and signal conduits such as wires or data cables. Other types of connectors can also be utilized, including the bearing-style connectors of FIGS. 8-12 that will be discussed in further detail below. In a further alternative, the bearings can be replaced with polished rings that do not rotate.

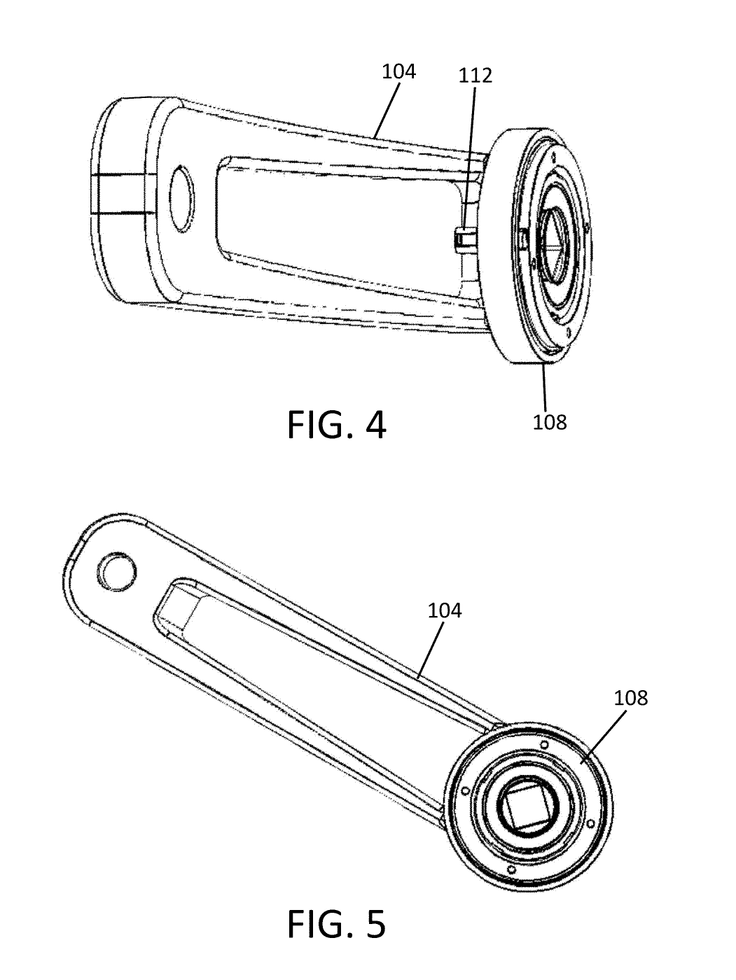

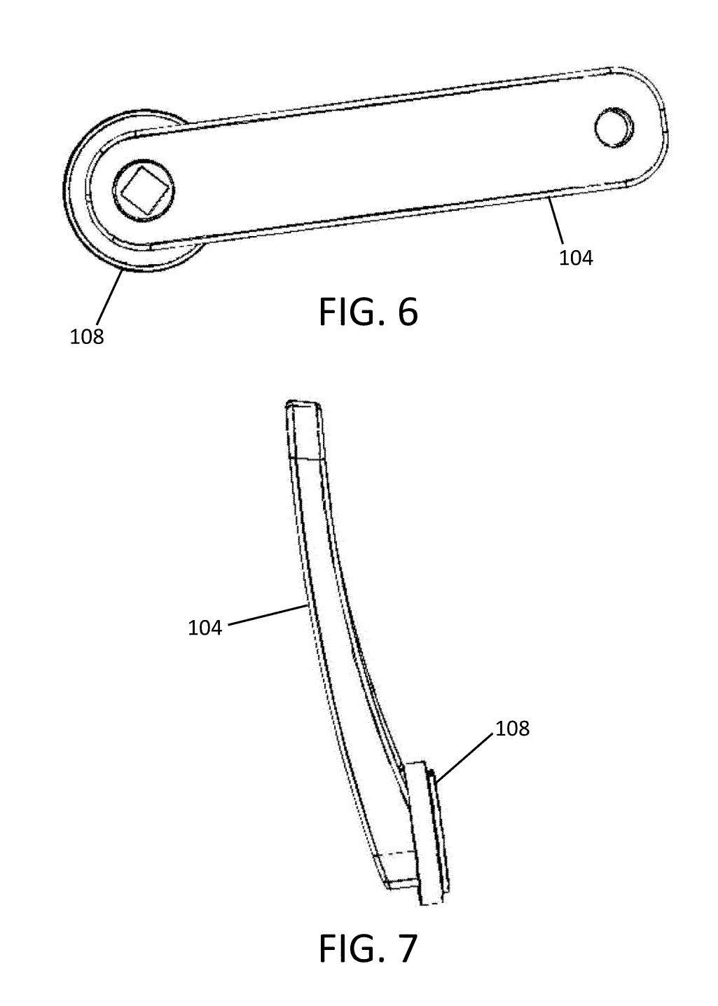

In the embodiment shown in FIG. 1, the pogo pin connectors 112 are fixed to the frame of the e-bike. However, as will be explained with respect to FIGS. 4-7, the reverse situation can also be provided where the slip rings are fixed to the crank. The pogo pin connectors 112 and slip rings 108 thus function to provide an electrical pathway between the rotating crank 104 to a stationary location on the e-bike.

More or fewer slip rings 108 can also be employed depending on how the system is configured in certain embodiments. For example, the data slip ring can be eliminated by passing the throttle data signals through the same path as the electrical power, or by making the signal transmission means wireless. The number of pogo pins connectors is varied accordingly. It is also contemplated that a single slip ring and pogo pin connector can be utilized in certain embodiments.

Referring to FIGS. 8-12, another means for providing rotational electrical connection to the control board 106 is disclosed. A plurality of slip rings 108a, 108b and 108c disposed in an outer carrier ring or hub 126 correspond to the respective conduits or wires 109a, 109b and 109c that carry the electrical power and throttle signals. A plurality of bearing pairs 128a, 128b and 128c are disposed in recesses in the inner hub or ring 130 and electrically connected to a respective wire or conduit 111a, 111b and 111c. Each bearing in the pairs of bearings 128a, 128b and 128c contact a respective inner surface of the slip rings 108a, 108b and 108c in order to pass electrical power and signals back and forth between wire segments 109a, 109b and 109c and 111a, 111b and 111c while the crank of the e-bike turns without wire binding.

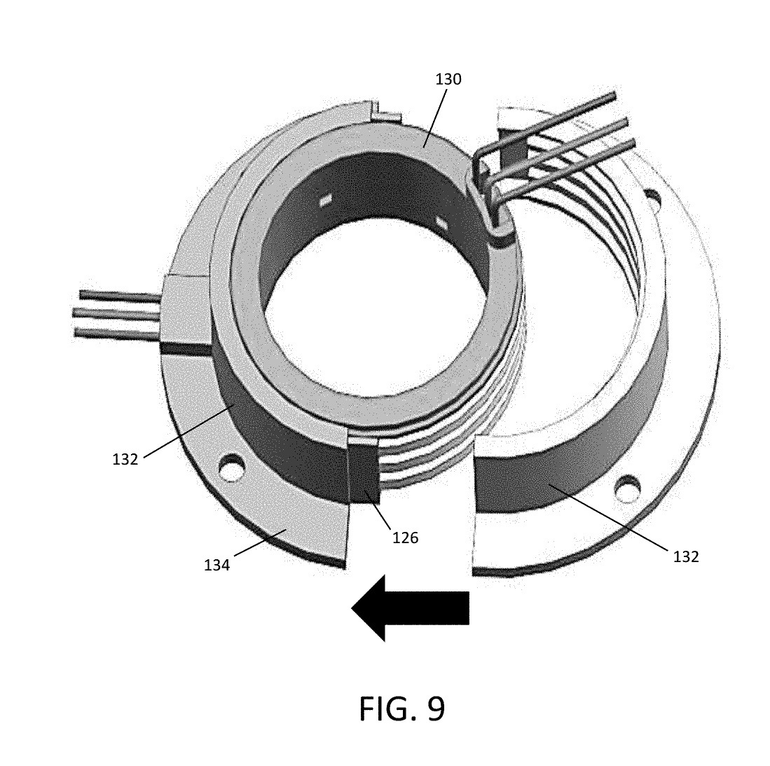

The large arrow shown in FIG. 8 indicates the insertion of the inner hub 130 into the outer hub 126. The bearings and slip rings will then be in alignment. An outer housing 132 with mounting flange 134 is disposed over the mated hubs 126 and 130 as shown in FIG. 9. The outer housing 132 can be formed as a two-part assembly that is joined as indicated by the large arrow in FIG. 9.

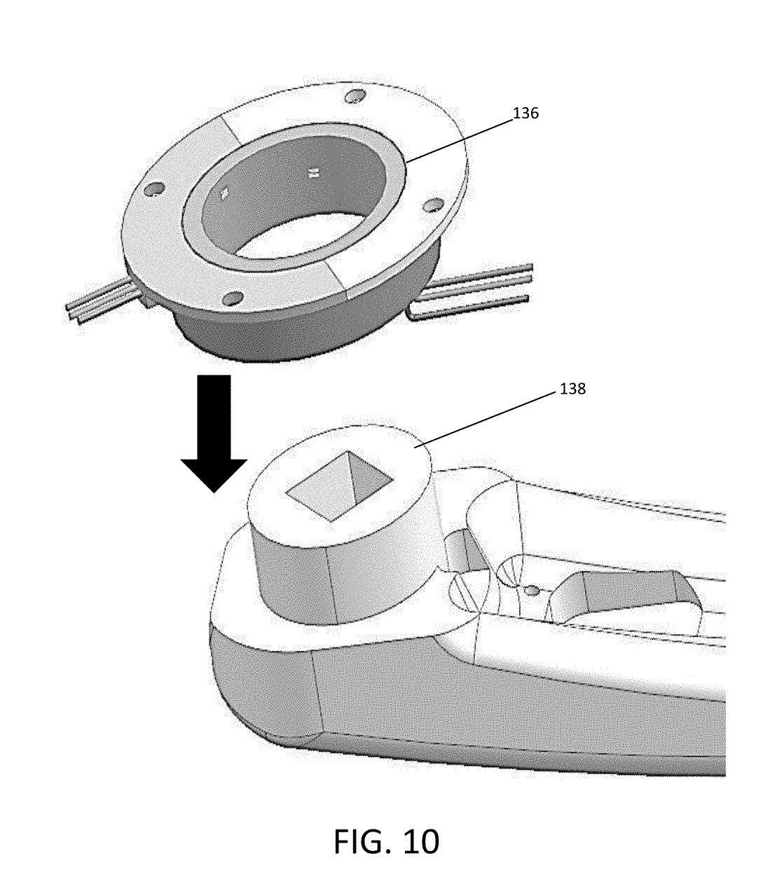

The final bearing connection assembly 136 is shown in FIG. 10. The assembly is disposed over the crank head 138 of the e-bike as indicated by the large arrow in FIG. 10. The flange 134 faces away from the crank as shown in FIG. 10 and is fixedly fastened to the e-bike's frame. However, the flange position mounting can be reversed so that the flange is fixedly fastened to the crank.

As can be seen in FIGS. 8, 11 and 12, each bearing of a bearing pair 128a, 128b and 128c is disposed at the opposing end of a respective resilient metal rod 129a, 129b and 129c. The rod is formed into a curved section and provides a spring force to keep the bearings in contact with the inner surface of the respective slip rings.

In a further aspect, an additional bearing can be placed over the crank head. The outer surface of this additional bearing then contacts the inner surface of the inner hub 130 so that the slip ring and bearing assembly 136 can rotate more smoothly as the crank rotates.

The bearing and slip ring assembly 136 can also be configured in the reverse manner of that depicted in FIGS. 8-12 and described above. In such embodiment, the slip rings 108a, 108b and 108c would be provided to the inner hub 130 and the bearings 128a, 128b and 128c would be provided to the outer hub 126.

A rotational bushing could also be used in place of the bearing to save cost.

In a further embodiment, the bearing components can be replaced with non-rotating slide rings that slip along the slip rings. Friction can be minimized by polishing the slide rings. The appearance of the slide rings would be approximately same as depicted in FIGS. 8, 11 and 12, with the difference being that the slide rings do not rotate about their center axis like bearings.

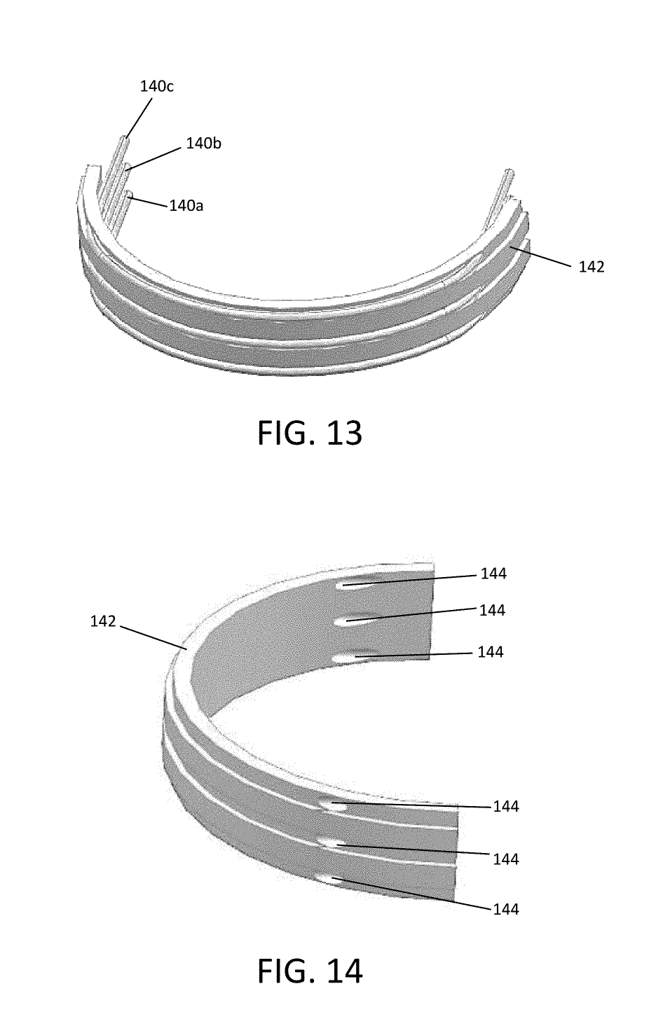

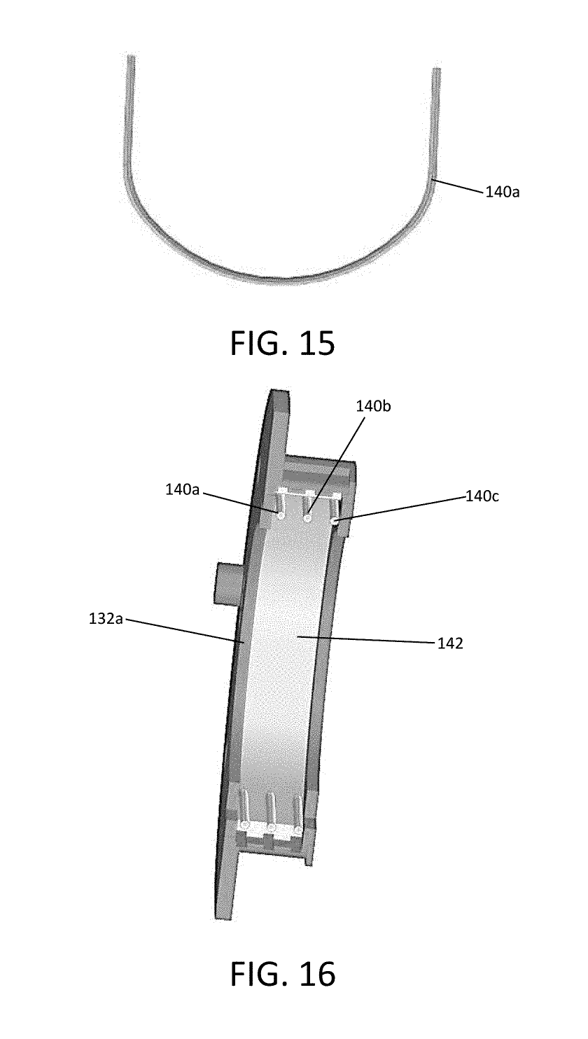

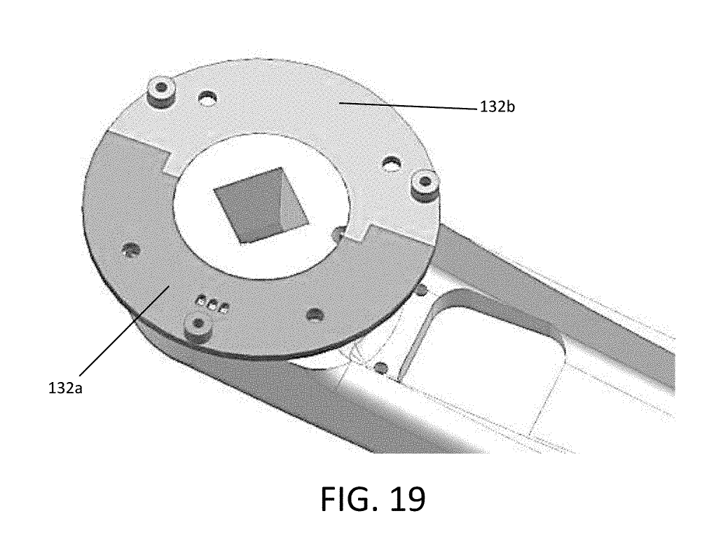

Referring to FIGS. 13-19, yet another means for providing rotational electrical connection to the control board 106 is disclosed. In this embodiment, a plurality of curved metal springs are provided that slide along the metal slip rings while the hub rotates. The springs 140a, 140b and 140c are curved so that they are generally U-shaped. The springs are disposed in a similarly-curved spring frame 142. Both ends of each spring are disposed through a respective aperture 144 defined through the frame 142 such that the ends protrude towards the inner curved side of the frame, which faces the hub of the e-bike.

Electric wires are soldered or otherwise attached to the appropriate spring. The spring/frame assembly, such as shown in FIG. 13, is disposed inside of the outer housing 132.

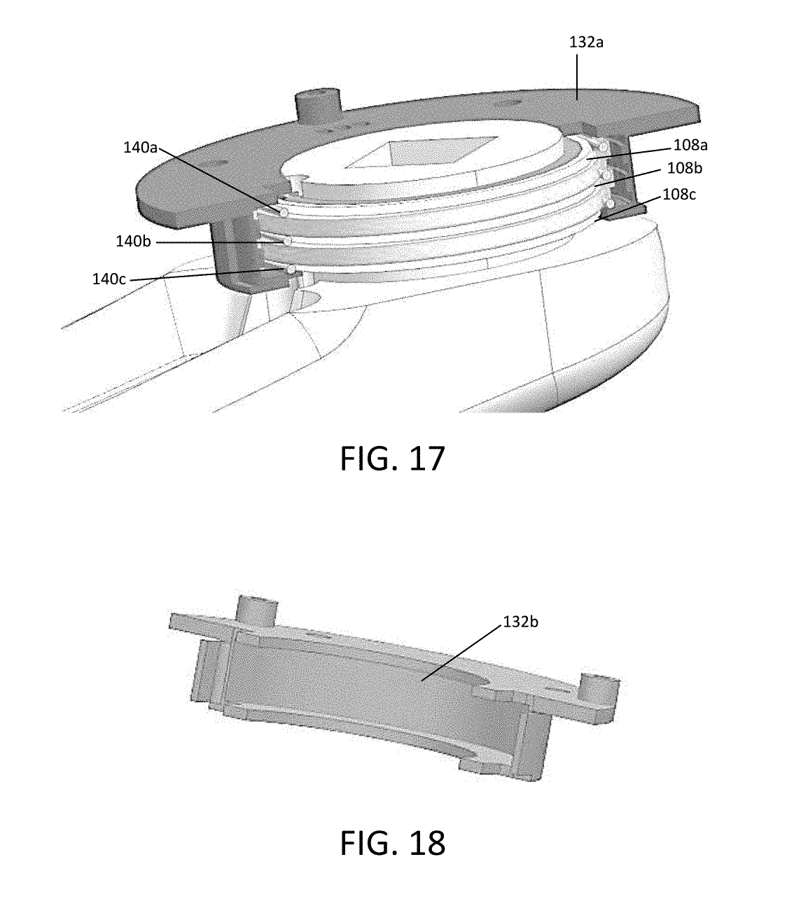

FIG. 17 illustrates the springs 140a, 140b, and 140c contacting a respective slip ring 108a, 108b and 108c.

The outer housing 132 can be a two-piece configuration 132a, 132b as shown in FIGS. 17-19. This depicted embodiment, the slip rings are disposed along the inner circumference and the springs are disposed along the outer circumference. However, it should be noted that the configuration can be reversed as well.

It is also possible to provide electrical contact utilizing more than one different means disclosed herein.

As with the pogo pins embodiment, the number of slip rings, polished rings, springs and bearings in various embodiments can be varied depending on the connectivity needs of a particular e-bike. For example, the data slip ring can be eliminated by passing the throttle data signals through the same path as the electrical power, or by making the signal transmission means wireless. Thus, any one of more numbers of slip rings and bearings can be provided.

The e-bike includes a conventional e-bike controller 114 that is coupled to the main battery and the drive motor via the DC Motor output 116. A bike brake input 118 is also supplied to the e-bike controller 114 so that the controller 114 knows when the rider applies their brakes.

The data output from the smart crank system 100 is received into the conventional e-bike controller 116 via the controller's throttle connector 120. Conventional e-bike controllers are configured to receive analog data input. Therefore, the controller 106 of the smart crank system 100 is configured to output throttle data as an analog signal. A digital-to-analog (D/A) converter can be included on the control board 106 for this purpose. The D/A converter can be included as part of the micro controller.

The throttle data can be in various forms. For example, the throttle data can be an analog output representing a throttle magnitude value for the e-bike controller. The throttle data can also be more complex, so that certain determined values, such as crank speed, crank position, crank torque, etc. are communicated to the e-bike controller.

The smart crank system can sense the torque of e-bike rider's pedaling force via the strain gauge 102. The smart crank micro controller can also calculate the speed and position of the crank based upon the motion sensor readings evaluated by the digital motion processor on the board 106. The motion sensors and digital motion processor can also be disposed on the crank separate from the board 106 and electrically coupled to the board 106.

The smart crank system can determine a total pedaling force of the rider based upon the measured pedaling force and crank position data. A crank angle defined between the horizontal plane and the longitudinal axis of the crank can be determined based upon the motion sensors and digital motion processor data. The measured pedaling force based upon the strain gauge data is multiplied by the cosine of the crank angle to determine the total pedaling force being exerted by the rider. Thus, the total pedaling force that is the combined force vector components in the vertical and horizontal planes can be computed. The total pedaling force can be used for computing the throttle data signal since it is more representative of the rider's applied pedaling power than the measured pedaling force based upon the strain gauge data.

The smart crank system 100 can also determine from the crank position whether the rider is braking, dismounting, resting, etc., and relay this determination to the e-bike controller 114.

The smart crank system 100 does not need a separate power source because it can be powered from e-bike controller 114 through the slip rings 108 and pogo pins 112. Alternatively, power can be supplied directly from the e-bike's main battery that is used to power the drive motor.

The smart crank system 100 can be retrofitted to existing e-bikes because the system 100 can interface with any existing e-bike through the convention throttle connector.

This smart crank system 100 can be applied to a variety of electrically-powered conveyances, including bicycles, monocycles, tricycles, wheelchairs, recumbent bicycles, exercise machines, etc., where the conveyance requires the rider to operate a leg or hand operated crank/handle. The power applied to crank/handle by the operator is thus used to decide the drive motor power output.

The invention can also be configured as an e-bike featuring the smart crank system disclosed herein.

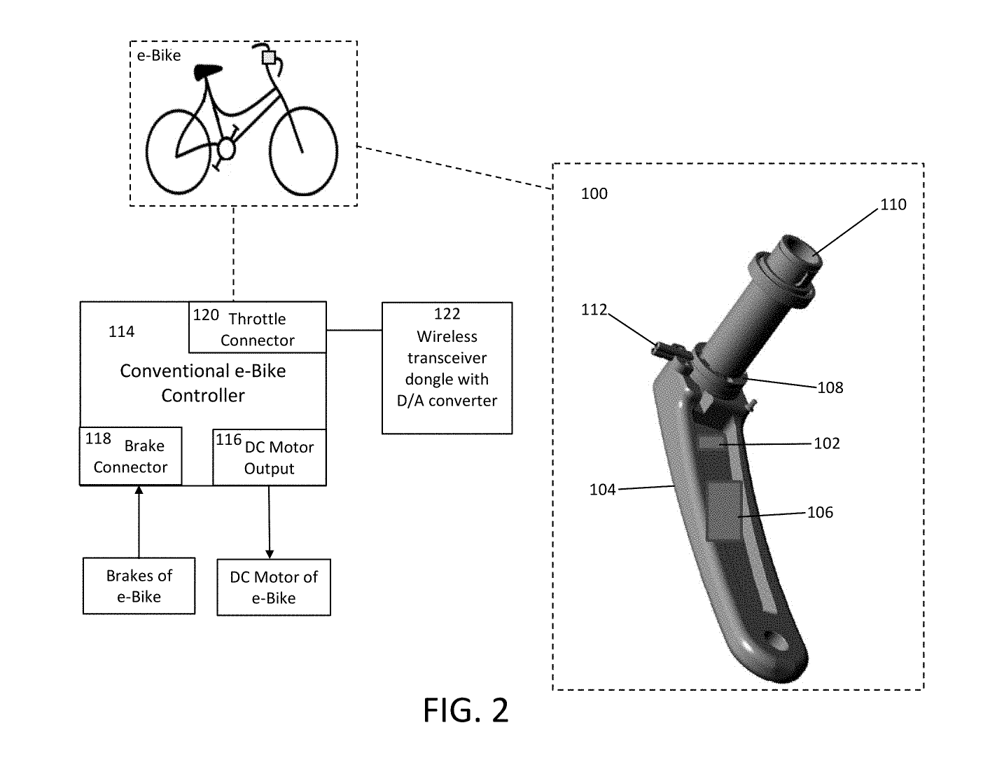

Referring to FIG. 2, the output of the control board can be wirelessly coupled to the e-bike controller 114 wirelessly via a wireless transceiver dongle 122. The board in this embodiment additionally includes a wireless transceiver to transmit the output data, which is then received by a wireless dongle 122 that is electrically coupled to the e-bike controller 114. The output from the board 106 can be digital, so a digital to analog converter is included in the dongle 122 to convert the data signals to analog for use by the e-bike controller 114. The wireless transmission means can be Bluetooth, Wi-Fi, ZigBee, cellular, radio frequency, or any other wireless transmission means.

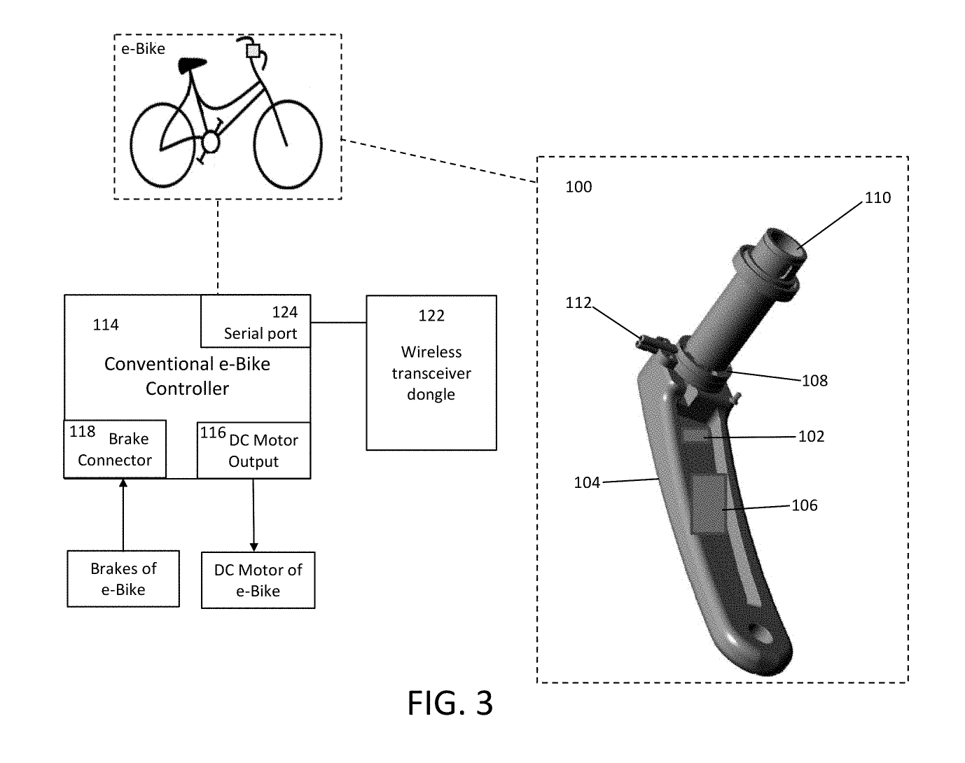

Referring to FIG. 3, the e-bike controller 114 includes a serial port 124, such as a universal asynchronous receiver-transmitter (UART) port. In this embodiment, the wireless dongle 122 connects to the serial port 122 and the dongle no longer needs to include the D/A converter. Other input types of input ports can alternatively be provided, including universal serial bus (USB) ports. It may be necessary to update the software code for the e-bike controller 114 if the controller does not support the data output protocols used by the micro controller on the smart crank board 106.

Referring to FIGS. 4-7, the crank 104 is shown. The slip ring 108 is disposed around the crank 108 while the pogo pin connector 112 rotates about the pedal axle 110 (in FIG. 1). The pedal (not shown) is disposed on the opposing end of the crank 104. The slip rings 108 and pogo pin connectors 112 permit the electrical signals and/or power to be transmitted through the rotating crank without binding up the wire cabling. In this embodiment, the wire 113 shown in FIG. 1 would be connected to the slip ring 108 and the smart crank board 106 would be connected to the pogo pin connectors 112.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A smart crank control system for an e-bike, the e-bike including a crank and an electric motor connected to an e-bike controller, the e-bike controller including a throttle connector, the smart crank system comprising:
a control board disposed on the crank, the control board including a motion sensor, a digital motion processor and a micro controller;
a plurality of slip rings disposed about the crank; and
a plurality of metal springs disposed about the crank,
wherein each of the metal springs is in physical contact with a respective one of the slip rings, and
wherein a power connection to the control board passes through the physical contact between at least one of the metal springs and the respective one of the slip rings.

2. The smart crank system of claim 1, further comprising a spring frame provided to the plurality of metal springs.

3. The smart crank system of claim 2, wherein the spring frame is curved and defines a plurality of apertures through which opposing ends of the plurality of metal springs can be disposed such that the opposing ends protrude inwardly of the curvature of the spring frame.

4. The smart crank system of claim 3, further comprising an outer housing, wherein the spring frame and the plurality of springs are disposed within the outer housing, and wherein the slip rings are disposed within an inner diameter of the plurality of slip rings.

5. The smart crank system of claim 1, wherein a throttle control signal from the control board passes through the physical contact between at least one of the metal springs and the respective one of the slip rings.

6. The smart crank system of claim 1, wherein the micro controller is configured to determine a crank speed, a crank position and a torque data for the crank of the e-bike and report a throttle data to the e-bike controller via the throttle connector.

7. The smart crank system of claim 6, wherein the control board further includes a digital to analog converter coupled to the micro controller so that the crank speed, the crank position and the torque data for the crank of the e-bike are converted to analog data.

8. The smart crank system of claim 1, wherein the control board further includes a digital to analog converter coupled to the micro controller so that a throttle data can be outputted to the e-bike controller in an analog format.

9. The smart crank system of claim 1, wherein a power input cable is connected to at least one of the plurality of metal springs.

10. The smart crank system of claim 1, wherein a data cable is connected to one of the plurality of metal springs.

11. The smart crank system of claim 10, wherein the data cable is also connected to the throttle connector of the e-bike controller.

12. A smart crank control system for an e-bike, the e-bike including a crank and an electric motor connected to an e-bike controller, the e-bike controller including a throttle connector, the smart crank system comprising:
a control board disposed on the crank, the control board including a motion sensor, a digital motion processor and a micro controller;
a plurality of slip rings disposed about the crank; and
a plurality of curved metal springs disposed about the crank,
a bearing disposed at an end of each of the plurality of curved metal springs,
wherein each of the bearings is in physical contact with a respective one of the slip rings, and
wherein a power connection to the control board passes through the physical contact between at least one of the bearings and the respective one of the slip rings.

13. The smart crank system of claim 12, further comprising an inner hub, wherein each of the plurality of metal springs is affixed to the inner hub.

14. The smart crank system of claim 12, wherein each bearing contacts an inner circumferential surface of a respective slip ring.

15. The smart crank system of claim 12, wherein each bearing is disposed at each end of each of the plurality of curved metal springs, which defines a bearing pair for each of the curved metal springs.

16. The smart crank system of claim 15, wherein each bearing pair contacts an inner circumferential surface of a respective slip ring.

17. A smart crank control system for an e-bike, the e-bike including a crank and an electric motor connected to an e-bike controller, the e-bike controller including a throttle connector, the smart crank system comprising:
a control board disposed on the crank, the control board including a motion sensor, a digital motion processor and a micro controller;
a plurality of slip rings disposed about the crank;
a plurality of curved metal springs disposed about the crank; and
a slide ring disposed at an end of each of the plurality of curved metal springs,
wherein each of the slide rings is in physical contact with a respective one of the slip rings, and
wherein a power connection to the control board passes through the physical contact between at least one of the slip rings and the respective one of the slip rings.

18. The smart crank system of claim 17, wherein each slide rings contacts an inner circumferential surface of a respective slip ring.

19. The smart crank system of claim 18, wherein each slide ring is disposed at each end of each of the plurality of curved metal springs, which defines a slide ring pair for each of the curved metal springs.

20. The smart crank system of claim 19, wherein each slide ring pair contacts an inner circumferential surface of a respective slip ring.
